(19) United States
(12) Patent Application Publication
(10) Pub. No.: US 2011/0179173 A1
(43) Pub. Date: Jul. 21, 2011

(54) CONDITIONAL DEPENDENCY IN A COMPUTING CLUSTER

(76) Inventors: Carol Colrain, Redwood Shores, CA (US); Andrey Gusev, Dublin, CA (US)

(21) Appl. No.: 12/688,800

(22) Filed: Jan. 15, 2010

(51) Int. Cl. G06F 15/173

(52) U.S. Cl. 709/226

(57) ABSTRACT

A method and apparatus is provided for automatically performing an operation for one or more resources of a computing cluster when a conditional dependency is satisfied. The conditional dependency may be based on the operating state, load, performance metric, or performance statistic of one or more other resources. A resource profile for a resource stores a conditional dependency that, when satisfied, causes a centralized policy engine to send a command to the resource or an agent for the resource. The policy engine receives notifications of operating state changes from agents that manage resources in the cluster. The policy engine determines that one or more conditional dependencies is satisfied when one or more resources change state to satisfy conditions specified by the conditional dependencies. The policy engine responds to detecting that a conditional dependency is satisfied by sending a command that causes the dependent resource to change its operating state.

### CROSS-REFERENCE TO RELATED APPLICATIONS

This application is related to the following applications:

(1) Application Ser. No. 12/NNN,NNN, entitled “Special Values In Oracle Clusterware Resource Profiles,” Attorney Docket Number 50277-3748, filed on even date herewith, the entire contents of which is hereby incorporated by reference as if fully set forth herein; (2) Application Ser. No. 12/NNN,NNN, entitled “‘Local Resource’ Type As A Way To Automate Management Of Infrastructure Resources In Oracle Clusterware,” Attorney Docket Number 50277-3750, filed on even date herewith, the entire contents of which is hereby incorporated by reference as if fully set forth herein; (3) Application Ser. No. 12/NNN,NNN, entitled “Unidirectional Resource and Type Dependencies In Oracle Clusterware,” Attorney Docket Number 50277-3751, filed on even date herewith, the entire contents of which is hereby incorporated by reference as if fully set forth herein; (4) Application Ser. No. 12/NNN,NNN, entitled “Self-Testable HA Framework Library Infrastructure”, Attorney Docket Number 50277-3746, filed on even date herewith, the entire contents of which is hereby incorporated by reference as if fully set forth herein; (5) Application Ser. No. 12/NNN,NNN, entitled “Dependency On A Resource Type”, Attorney Docket Number 50277-3747, filed on even date herewith, the entire contents of which is hereby incorporated by reference as if fully set forth herein; (6) Application Ser. No. 12/NNN,NNN, entitled “Dispersion Dependency In Oracle Clusterware,” Attorney Docket Number 50277-3749, filed on even date herewith, the entire contents of which is hereby incorporated by reference as if fully set forth herein. The applicants hereby rescind any disclaimer of claim scope in the related applications.

### FIELD OF THE INVENTION

The present invention relates to managing resources in a clustered computing environment.

### BACKGROUND

In a clustered computing environment, computer components work together to execute instructions, provide services, and perform other functions. A simple computing environment includes a processor, a memory device, and an application stored on the memory device that provides instructions to the processor. The memory device and the processor may work together even when the memory device is on a different machine and a different network than the processor.

In one example, in order to provide a service over a network, the clustered computing environment may include a processor, a memory device, and a network device that provides a connection to the network. The network device in the example may use a network address that is issued when the network device is registered with the network. The network device may also use a network listener to listen for requests for the service that are sent to the network device.

The components used by the clustered computing environment in the example include a processor, a memory device, a network device, a network address, and a network listener. The clustered computing environment may use a variety of components or resources to support a variety of applications, provide a variety of services, or support any other task that is performed in the clustered computing environment. A resource is any component that may be utilized in the computing system and managed by a resource manager. Resources include: logical representations of computer components such as an allocation of memory; logical configurations of computer components such as a network address associated with a computer component; a set of instructions or an application that may be utilized by another computer component; physical computer components such as a disk, a network device, or a processor; and components with both logical and physical computer components such as a disk loaded with a set of instructions. In one example, a cluster may include, but is not limited to, the following resources: a disk, an allocation of memory, a processor, an application, a database instance, a connection pool, a mid-tier server, an application server, a service, an automatic storage management (ASM) instance, and a listener.

In order to implement a dependency amongst resources, custom software needed to be written. Such custom code needed to execute logic on an agent that manages one resource to start or stop other resources whenever the resource managed by the agent changes state. In other words, custom configuration code used to start one resource may also start other resources. For example, instructions to start application A may also include instructions, or custom code, for starting processor P, for starting memory device M, and for starting network device N. Custom code written for A according to a “hard dependency” does not allow A to start until the code has successfully executed to start P, M, and N. Custom code written for A according to a “weak dependency” proceeds to start A after the code has been executed to start P, M, and N, regardless of the result of executing code to start P, M, and N.

In another example, if a customer wanted to start reporting services when high-priority business services stopped, custom code needed to be added into the resource layers, such as to a particular agent that manages a particular resource. And if the particular agent wanted to stop these reporting services when the high-priority business services started, yet more custom code needed to be added to the resource layers.

A clustered computing environment may be managed by writing custom configuration code to start, stop or check a resource in the computing environment when another resource changes state. In the example for application A, the custom code written to start application A also starts P, M, and N. For computing environments with large amounts of applications and resources, the custom configuration code is very complex and is subject to race conditions and timing issues. Application developers and administrators are likely to make mistakes due to the difficulty in keeping track of the custom configuration code and the available resources. Additionally, applications that utilize the same resources may be started at the same time, resulting in a competition for those resources. Also, writing the custom configuration code for each application involves a substantial amount of effort and familiarity with the clustered computing environment. Using custom code resulted in duplicated effort and competing decision makers in the cluster with potential for inconsistent results and timing errors.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating example resource profiles.

FIG. 2 is a diagram illustrating an example cluster that includes a policy engine with access to resource profiles.

FIG. 3 is a diagram illustrating an example technique for sending a command to an agent when a condition is satisfied.

FIG. 4 is a diagram of an example computer system upon which techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for automatically performing an operation for one or more resources of a computing cluster when a logical expression depending on an operating state of one or more other resources of the computing cluster has been satisfied. A resource profile for a resource stores a conditional dependency that specifies that condition. The condition depends on the operating states of one or more other resources. The conditional dependency is associated with an operation to be performed when the conditional is satisfied. In one embodiment, a policy engine detects that a conditional dependency specifying a condition is satisfied when one or more resources specified in the condition have one or more operating states that are associated with the conditional dependency. For example, the policy engine may receive a notification that a first resource is online and, based in part on the notification, determine that a conditional dependency for a second resource is satisfied. The policy engine may respond to detecting that the condition is satisfied by sending a command to the second resource or to an agent managing the second resource to start or stop that resource. For example, the command may cause the agent to start the second resource or to stop the second resource when the condition is satisfied.

In one embodiment, if a condition is satisfied among Clusterware resources expressed in the dependency, the Clusterware should operate on the dependent resource. The conditional dependency can be used in the start-dependencies for a resource or in the stop-dependencies for a resource. When the conditional dependency defined in the start-dependencies for a resource is satisfied, the Clusterware starts that resource. When the conditional dependency defined in the stop-dependencies for a resource is satisfied, the Clusterware stops that resource. The expression in the conditional dependency can specify any Boolean condition. The condition is evaluated by the Clusterware's policy engine at each state change (such as online, offline, or intermediate) of resources in the cluster.

The Clusterware may start or stop the dependent resource anywhere in the cluster. There is no requirement that the resource is on the same machine or system, and the policy engine does not need to use any resource-specific commands. The start and stop commands, among others, may be global with respect to the Clusterware environment. The resource is started or stopped anywhere in the cluster when the conditional dependency is satisfied. The conditional dependency may cause the dependent resource to start or stop on any or the same node where the resource is parameterized in the Clusterware environment.

In one example, conditional (A) in a start dependency for B means start B when A comes ONLINE. In one embodiment, the conditional dependency affects resource B if resource B is not already running. In another example, conditional (A) in a stop dependency for B means stop B when A comes ONLINE. In one embodiment, the conditional dependency affects resource B if resource B is not already stopped. In other examples, conditional (A, C) in a start dependency for B means start B when both A and C come ONLINE; conditional (A, C) in a stop dependency for B means stop B when both A and C come ONLINE; conditional (A or C) in a start dependency for B means start B when A or C come ONLINE; and conditional (A or C) in a stop dependency for B means stop B when A or C come ONLINE.

In another variation of the conditional dependency, the TARGET of a resource can be defined in the BOOLEAN expression. This allows a user to model a change in TARGET state in the Boolean expression, examples being ONLINE or OFFLINE. The Boolean expression offers a modifier to let users specify the value of the TARGET state. By default, the Boolean expression is satisfied using TARGET ONLINE. In this variation, if resource A has a conditional relation to resources OFFLINE (B, C), then A will be started or stopped when B changes state to OFFLINE and C is OFFLINE, or when C changes state to OFFLINE and B is OFFLINE, or when both B and C change state to OFFLINE concurrently. In another embodiment, the expression may define more than one target state for more than one resource. For example, the expression may be satisfied when B is offline and C is online.

In a further variation, a resource type, as opposed to a concrete resource, may be used in the expression. The relationship is satisfied when “any resource of the type” in the relationship satisfies the condition. For example, conditional(Type:T) may be satisfied when any resource of type T is online. Type:T may also be used in a Boolean expression that determines the condition. For example—conditional(Type:T and NOT Type:S).

The key point is the conditional dependency allows any valid Boolean expression to be declared in the resource profile. When the condition is satisfied, the start or stop operation is executed by the policy engine.

### Resources

A resource is any component that may be utilized in the computing system and managed by a resource manager. Example resources include, but are not limited to, a processor, a volatile or non-volatile storage device, a logical allocation of memory, a network device, a network address, a network listener, an application, a database instance, a connection pool, a mid-tier server, an application server, a service, an automatic storage management (ASM) instance, or any other physical or logical computing component that can be managed by a resource manager. The techniques described herein are not limited to any particular resource, group of resources, or type of resources.

The resources and dependencies involved in a particular clustered computing system will vary depending on the needs and purposes of the system, as well as the quality and quantity of the resources. Therefore, no particular combination of resources is believed to be a best or optimal combination of resources. Further, resources that logically depend from one another may be configured to depend from one another according to the techniques described herein. For example, a database service may logically depend on at least one database instance, at least one ASM instance, and at least one disk group. The conditional dependency provides the flexible and powerful modeling needed to describe the relationships such as this that otherwise require duplicated custom code to handle.

### Resource Profiles and Conditional Dependency

Resource profiles may include any information about a resource, such as the name of a resource and status information such as whether or not a resource is online. In one embodiment, information for the resource profile is provided in a notification about the resource from an agent. In one embodiment, the policy engine receives event notifications from the agents, and acts on these events according to rules. In another embodiment, information for the resource profile is determined based on other information known to the policy engine, such as a command sent by the policy engine to change the state of the resource. In one embodiment, the resource profiles are stored in shared storage for the cluster, and the policy manager has access to the shared storage.

In one embodiment, the resource profile for a resource identifies one or more other resources that are in a conditional dependency relationship with the resource. In one embodiment, the resource depends on the status of at least one of the one or more other resources described in the condition in the resource's conditional dependency. A change in status of at least one of the one or more other resources may trigger an operation to be performed on the resource. For example, the conditional dependency may identify two other resources. In one embodiment, an operation is triggered on the resource when both of the other resources are in a particular operating state. In another embodiment, the operation is triggered on the resource when any of the other resources are in a particular operating state specified by the conditional dependency.

In one embodiment, the resource profile includes a conditional dependency that specifies a condition that is satisfied when a logical combination of one or more computer resources have one or more operating states. In a particular embodiment, the condition in a resource profile for a resource may be a startup condition that specifies when the resource should be started. For example, the startup condition for resource C may be “conditional (A, B),” which specifies that resource C should be started when resources A and B are both online.

The condition specified by the conditional dependency may specify one or more triggering operating states to be detected on any logical combination of resources. In one embodiment, the conditional dependency is a Boolean expression that identifies a logical combination of one or more resources or resource types with operators such as AND, OR, XOR, NAND, NOR, and NOT. For example, resources A and B may be identified in a conditional form with the AND operator, “AND (A,B).” In another embodiment, the AND operator or some other logical operator is a default operator when more than one resource is listed in the condition.

In one embodiment, the operating state associated with the condition is a default operating state. For example, a conditional dependency conditional(A, B),” may by default be associated with an online operating state. In other words, the condition in the dependency is satisfied with both A and B are online. As an alternate example, a condition may by default be associated with the offline operating state. In other words, the condition in the dependency is satisfied when both A and B are offline. In this manner, the conditional dependency may be associated with an operating state implicitly, by default, even if the operating state is not explicitly listed in the condition or in the resource profile.

Optionally, the conditional dependency may be satisfied when any resource of a group or of a type has one or more operating states specified by the conditional dependency. Alternately, the conditional dependency may be satisfied when a specified number of resources of one or more groups or one or more types have one or more operating states specified by the conditional dependency. For example, the policy engine may detect that a condition, “5(type:A),” is satisfied, meeting the conditional dependency, when 5 resources of type A are online. In another example, the policy engine may detect that a condition, “(group:B),” is satisfied when any resource of group B is online.

Resource types are described in U.S. patent application Ser. No. ______, Attorney Docket Number 50277-3747, which has been incorporated by reference herein in its entirety. A type or a group to which a resource belongs may be identified in the resource profile. In one embodiment, the type is referred to in the resource profile and defined in a type definition. In one embodiment, the group includes a discrete set of one or more resources.

In another example, resource A may be started when resource B AND a resource of type T are started even if the TARGET of A is not ONLINE. An example expression representing this conditional dependency is: conditional:always(B, type:T). In another example, a conditional dependency may be satisfied when any one or more resources in a list changes state to ONLINE. An example expression representing this conditional dependency is: conditional:([A or B or C or D]). This expression may be modified so that the conditional dependency is satisfied when at least two of the resources in the list are online. For example, an expression satisfied when at least two resources are online is: conditional:2([A, B, C, D]). The conditional dependencies may be start dependencies or stop dependencies. In other words, the dependent resource may be started or stopped when the conditional dependency is satisfied. In another embodiment, another operation is performed on the dependent resource whenever the conditional dependency is satisfied.

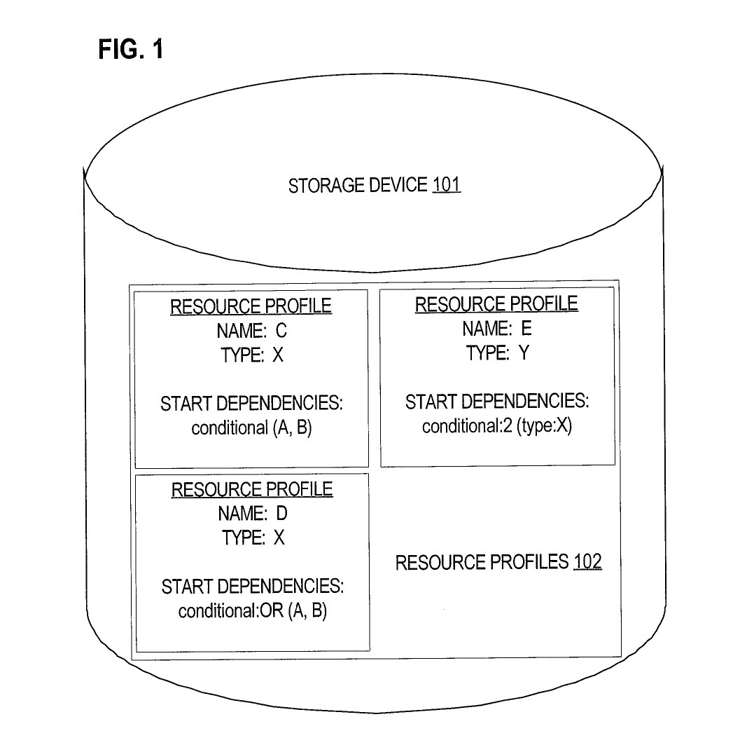

FIG. 1 shows a storage device 101 that stores resource profiles 102. In the example, three resource profiles 102 are listed. A resource profile for resource C includes the resource name, C, the resource type, X, and a start dependency for the resource. As shown, resource C is to be started when both A and B are online. In another embodiment, resource C may have a conditional dependency that is based on other states of A and B. FIG. 1 also shows a resource profile for resource D, also of type X, which includes a start dependency that specifies that resource D is to be started when either resource A or resource B are online. Also as shown, a resource profile for resource E, of type Y, has a start dependency that specifies that resource E is to be started when any two resources of type X are online.

A condition in the conditional dependency may be dependent upon any state of any of one or more resources in the cluster. The conditions are monitored by the policy engine, which may cause any operation to be performed on one or more other resources whenever the policy engine detects that the condition is satisfied.

### Evaluating the Conditional Dependency

An operating state is one or more values that describe the current or last known status of one or more resources. In one embodiment, the operational state associated with the condition stated in the conditional dependency is one or more of the following: offline, online, intermediate (transitioning between an offline state and an online state), or unknown. For example, an agent application that controls the resource may notify the policy engine that a resource is now offline. One or more conditional dependencies may be satisfied when the resource goes offline.

In one embodiment, one or more conditional dependencies may be satisfied when a logical combination of resources specified by the condition are online, or running. In another embodiment, the one or more conditional dependencies may be satisfied when the logical combination of resources is offline, not running, or stopped. One or more conditional dependencies may alternately be satisfied when the logical combination of resources is in an unknown state. The unknown state may occur when an attempt to clean up the resource has failed. Human intervention may be required to reset a resource from the unknown state. One or more conditional dependencies may also be alternately be satisfied when the logical combination of resources is in an intermediate state, such as starting or stopping. The intermediate state may describe a resource whose current state is unknown, but was either attempting to go online or was online the last time the state was known.

In one embodiment, the policy engine may determine that a resource is in the intermediate state when the policy engine determines to start a stopped resource, or to stop a started resource. The policy engine may keep the resource in the intermediate state until the policy engine receives information that indicates that the resource has changed state. The policy engine enforces conditional dependency rules in response to state changes.

In one embodiment the change in operating state associated with a resource triggers evaluation of one or more conditional dependencies. The policy engine may detect that one or more conditional dependencies are satisfied based at least in part on one or more commands that the policy engine determines to send to one or more other resources. For example, the policy engine may detect that a condition for resource C, which requires resources A and B to be in either the intermediate state or in the online state, is satisfied when the policy engine according to a conditional dependency. The policy engine may already have access to information, through the occurrence of a state-changing event or otherwise, that resource A is already in the intermediate or online state. When the policy engine determines to start resource B, the policy engine may treat the conditional dependency as satisfied before, concurrently with, or after a command is sent to start another resource C. A command triggered by a conditional dependency for resource C may be sent to resource C before, concurrently with, or after the command is sent to start another resource B.

Optionally, a conditional dependency may be conditioned upon a load, performance metric, or performance statistic of a resource. For example, the actual percentage of the CPU being used conditional(CPU: “75%”) or the average IO service time conditional (disk:20 ms). As another example, the load, performance metric, or performance statistic may be sent when the resource becomes loaded beyond a threshold, or when the metric or statistic goes beyond a threshold amount and is used by the policy engine to evaluate conditions in conditional dependencies.

The techniques described herein are not limited to any particular technique for receiving information that indicates a change in operating states, and a person of ordinary skill would understand that there are infinitely many ways to implement such a system. Specific examples of operating states and event-based systems are provided in order to facilitate a better understanding of specific implementations.

In one embodiment, an agent for a resource notifies the policy engine of a state-changing event whenever the operating state of the resource changes or passes a threshold. In another embodiment, the agent notifies the policy engine of state-changing events periodically regardless of whether the operating state of the resource changes. In another embodiment, the agent sends the policy engine load information periodically. In yet another embodiment, the agent sends operating state updates when the current operating state is requested. In one embodiment, when a resource experiences a change in operating state, an agent for the resource publishes a notification event. The policy engine subscribes to the notification events and receives the notification of the change in operating state. In one embodiment, the policy engine maintains the information about the last known operating states of resources in memory, on disk, and/or in a shared database.

### Commands for Resources

The operation executed when a conditional dependency is satisfied may be any command for the resource. In one embodiment, the command is one of a set of global commands defined for all resources in the cluster. In one embodiment, the command is a command that changes the state of the resource when the command is successfully executed. The command may be executed by the resource, or the command may instruct an agent to execute instructions to manage the resource. For example, the resource may be started when a start dependency is satisfied by sending a start command to an agent application that controls the resource. The start command, if successful, changes the operating state of the resource to online. In one embodiment, an agent receiving a start command does nothing if the resource is already online. In another embodiment, an agent receiving a stop command does nothing if the resource is already offline. Agents for different resources may handle the commands differently.

In one embodiment, the operation is starting or stopping the resource, causing the resource to go online or offline. In another embodiment, the operation is to clean up the resource. Cleaning up the resource may include, for example, stopping the resource, deleting the temporary variables, and causing the resource to enter a default or initial state such as offline or online. In one embodiment, the operation is to check the resource by retrieving an operating state of the resource. The operating state may be provided to the policy engine. A resource may be checked in response to receiving a command from the policy engine, periodically even when a command is not received from the policy engine, or in response to the occurrence of an event, such as a failure of the resource, a completed boot sequence, or any other event that may change the state of the resource.

### Policy Engine

A cluster includes a policy engine that, amongst other cluster-wide tasks, detects whether the conditional dependencies that depend on operating states of computer resources are satisfied. In one embodiment, a determination that a condition within a conditional dependency is satisfied is based in part on notifications of changes in operating states of computer resources received by the policy engine from the agents managing those resources. For example, the policy engine may receive a notification that a computer resource is online and evaluate dependencies that include this computer resource to determine if the condition is satisfied. In another embodiment, the determination may be based in part on the policy engine determining to send commands to change the state of one or more resources. For example, the policy engine may detect that a computer resource is in an intermediate operating state when the policy engine determines to send a command for the resource to be started. That is, the policy engine itself determines that a conditional dependency rule is satisfied for one dependent resource after the policy engine sends out a command to another resource and that request has completed. If the policy engine detects that one of the dependency conditions is satisfied, then the policy engine performs one or more responsive actions associated with the satisfied dependency condition.

In one embodiment, if a node that includes the policy engine fails, then another node in the cluster starts a policy engine to assume responsibility for conditional dependency determinations and other tasks in the cluster. In one embodiment, the resource profiles and information about operating states are backed up using shared memory. In another embodiment, nodes that do not include the policy engine also subscribe to the notifications and maintain a copy of the resource profiles and operating states. The techniques described herein are not limited to any particular technique for backing up or making the relevant information available upon failure of a node that previously ran the policy engine.

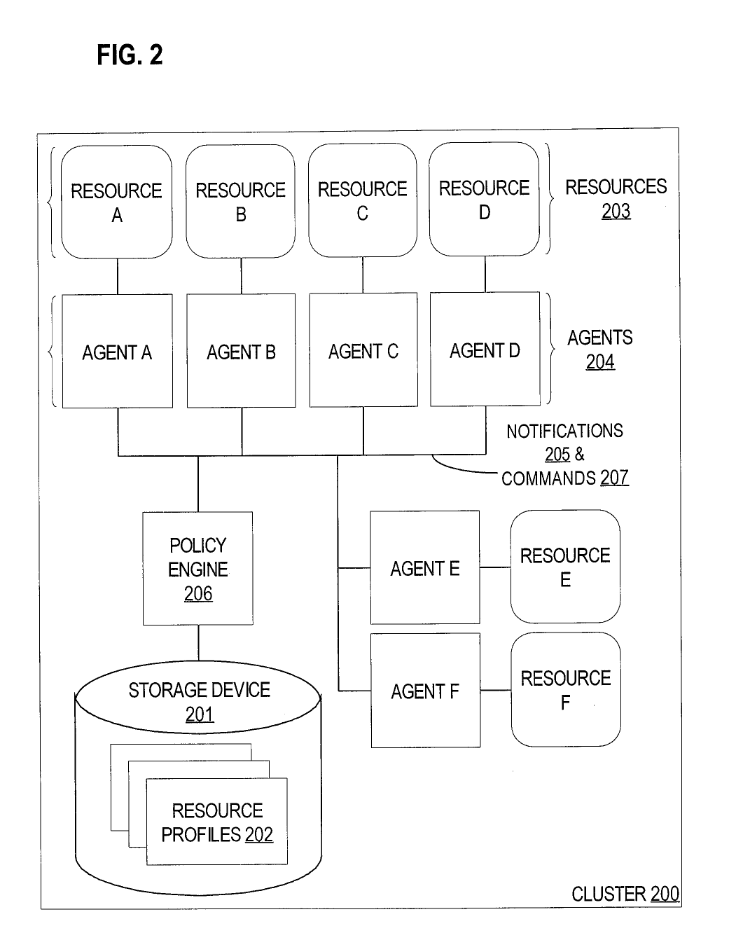

FIG. 2 illustrates an example cluster 200 with resources 203 that are each managed by agents 204. Agents 204 send notifications 205 to policy engine 206 as the operational states of resources 203 change, periodically, or in response to requests or events. Policy engine 206 accesses resource profiles on storage device 201 in order to determine whether any conditions specified in resource profiles 202 are satisfied. If a condition in resource profiles 202 is satisfied, then policy engine 206 sends commands 207 to agents 204. Agents 204 receive commands and execute instructions on resources 203 to carry out commands 207.

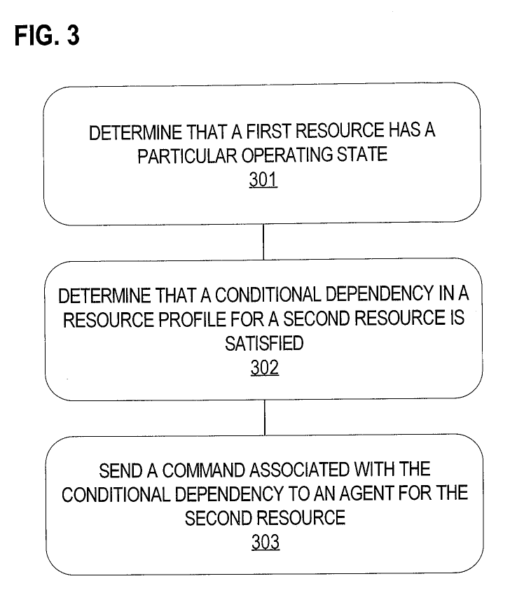

FIG. 3 illustrates an example technique for enforcing a conditional dependency in a centralized policy engine. In step 301, the policy engine determines that a resource has a particular operating state. For example, the policy engine may receive a notification from an agent for the resource indicating that the resource is online. In step 302, the policy engine determines that the conditional dependency in a resource profile for another resource is satisfied. For example, a conditional dependency that depends on the particular resource and one or more other resources may be satisfied when the particular resource comes online. In step 303, the policy engine sends a command associated with the conditional dependency to an agent for the other resource. For example, the policy engine sends a command to an agent that manages the resource named in the resource profile.

### Example Conditional Dependencies

One or more database instances may access their data using the ASM instance configured for the node, thus being represented as the ‘database’ and ‘asm’ resources with the former requiring the latter to be running. Should the ASM instance be brought down for maintenance or failure and thereafter be restarted (when the maintenance is complete or the reason for the failure has been addressed), all the database instances that were stopped/failed because they required the ASM instance need to be automatically restarted. In the absence of a conditional dependency, the database instances would not be automatically restarted. Similarly, if database instances have services defined, those service resources could define conditional dependencies so that the Clusterware starts those services whenever an instance is started.

In one example, the policy engine pushes up the database server whenever the ASM restarts, based on a conditional dependency for the database server. In another example, the policy engine pulls down a report service when a specified number of business services start. For example, the specified number of business services may be provided in a conditional dependency for the report service.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

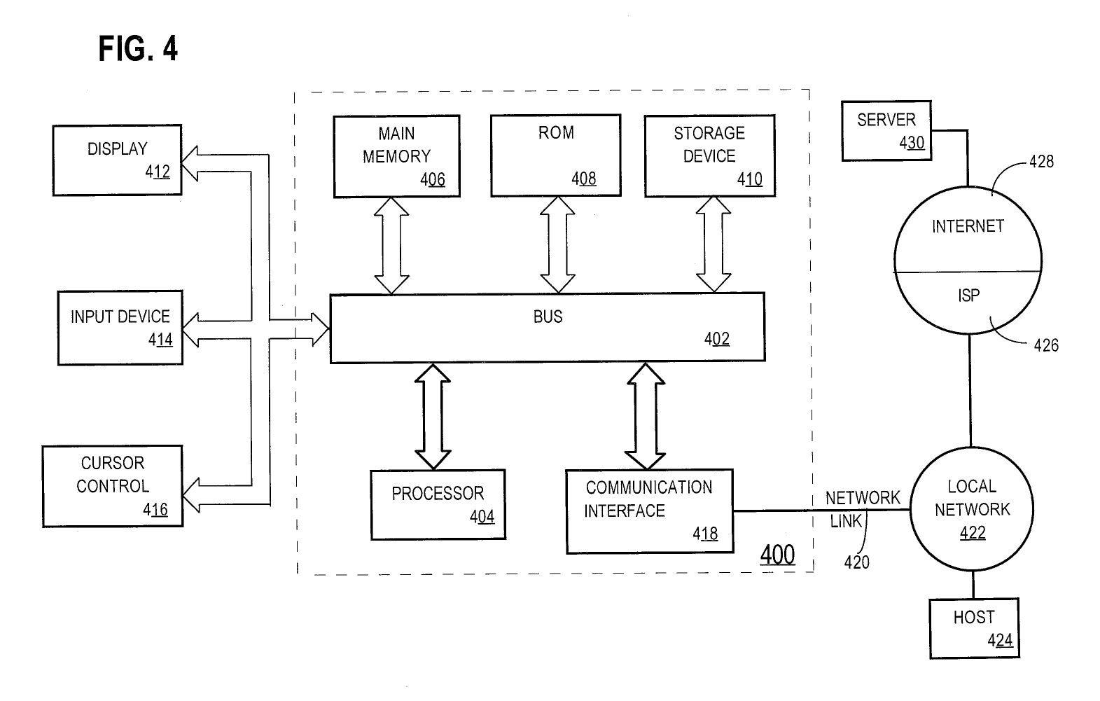

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
storing information for one or more first computer resources of a cluster, wherein the information identifies:
one or more second computer resources in a conditional dependency relationship with the one or more first computer resources, and
an operation to be executed for the one or more first computer resources;
detecting that at least one of the one or more second computer resources is in an operating state specified by the conditional dependency; and
in response to the detecting, causing execution of the operation for the one or more first computer resources;
wherein the method is performed by one or more special-purpose computing devices.

2. A method as recited in claim 1, wherein the operating state indicates that the one or more second computer resources is offline, online, transitioning between an offline state and an online state, or in an unknown state.

3. A method as recited in claim 1, wherein the causing execution of the operation comprises starting, stopping, cleaning up, or checking the one or more first computer resources.

4. A method as recited in claim 1, wherein the information comprises a logical expression that is satisfied if the one or more second computer resources has the operating state specified by the conditional dependency.

5. A method as recited in claim 1, wherein the one or more second computer resources comprises at least two second computer resources, and wherein the information comprises a logical expression that is satisfied when the one or more second computer resources has the operating state specified by the conditional dependency.

6. A method as recited in claim 1, wherein the information comprises a logical expression that is satisfied if any computer resource of a group of computer resources has the operating state, and wherein the one or more second computer resources are identified by the group.

7. A method as recited in claim 1, wherein the information comprises a logical expression that is satisfied if a specified number of computer resources of a group of computer resources have the operating state, and wherein the one or more second computer resources are identified by the group.

8. A method as recited in claim 1, wherein the detecting includes receiving a notification that the one or more second computer resources is in the operating state specified by the conditional dependency, and wherein causing execution of the operation for the one or more first computer resources further causes the one or more first computer resources to transition from one operating state to another operating state.

9. One or more storage media storing one or more sequences of instruction which, when executed by one or more computing devices, causes:
storing information for one or more first computer resources of a cluster, wherein the information identifies:
one or more second computer resources in a conditional dependency relationship with the one or more first computer resources, and
an operation to be executed for the one or more first computer resources;
detecting that at least one of the one or more second computer resources is in an operating state specified by the conditional dependency; and
in response to the detecting, causing execution of the operation for the one or more first computer resources.

10. One or more storage media as recited in claim 9, wherein the operating state indicates that the one or more second computer resources is offline, online, transitioning between an offline state and an online state, or in an unknown state.

11. One or more storage media as recited in claim 9, wherein the causing execution of the operation comprises starting, stopping, cleaning up, or checking the one or more first computer resources.

12. One or more storage media as recited in claim 9, wherein the information comprises a logical expression that is satisfied if the one or more second computer resources has the operating state specified by the conditional dependency.

13. One or more storage media as recited in claim 9, wherein the one or more second computer resources comprises at least two second computer resources, and wherein the information comprises a logical expression that is satisfied when the one or more second computer resources has the operating state specified by the conditional dependency.

14. One or more storage media as recited in claim 9, wherein the information comprises a logical expression that is satisfied if any computer resource of a group of computer resources has the operating state, and wherein the one or more second computer resources are identified by the group.

15. One or more storage media as recited in claim 9, wherein the information comprises a logical expression that is satisfied if a specified number of computer resources of a group of computer resources have the operating state, and wherein the one or more second computer resources are identified by the group.

16. One or more storage media as recited in claim 9, wherein the detecting includes receiving a notification that the one or more second computer resources is in the operating state specified by the conditional dependency, and wherein causing execution of the operation for the one or more first computer resources further causes the one or more first computer resources to transition from one operating state to another operating state.

17. A method comprising:
storing information for one or more first computer resources of a cluster, wherein the information identifies:
one or more second computer resources in a conditional dependency relationship with the one or more first computer resources, and
an operation to be executed for the one or more first computer resources;
detecting that at least one of the one or more second computer resources meets a load, performance metric, or performance statistic specified by the conditional dependency; and
in response to the detecting, causing execution of the operation for the one or more first computer resources;
wherein the method is performed by one or more special-purpose computing devices.

18. One or more storage media storing one or more sequences of instruction which, when executed by one or more computing devices, causes:
storing information for one or more first computer resources of a cluster, wherein the information identifies:
one or more second computer resources in a conditional dependency relationship with the one or more first computer resources, and
an operation to be executed for the one or more first computer resources;
detecting that at least one of the one or more second computer resources meets a load, performance metric, or performance statistic specified by the conditional dependency; and
in response to the detecting, causing execution of the operation for the one or more first computer resources.
